(19) United States
(12) Patent Application Publication
(10) Pub. No.: US 2026/0221672 A1
(43) Pub. Date: Jul. 30, 2026

(54) COMPRESSION CONNECTOR LUG WITH TRANSPARENT SLEEVE

(71) Applicant: NSi Industries, LLC, Huntersville,, NC (US)

(72) Inventors: Joseph Saganowich, Huntersville, NC (US); Jisselly Lemus, Huntersville, NC (US); Frank Foster, Huntersville, NC (US)

(21) Appl. No.: 19/464,003

(22) Filed: Jan. 29, 2026

Related U.S. Application Data
(60) Provisional application No. 63/751,478, filed on Jan. 30, 2025.

(51) Int. Cl. H01R 4/18

(52) U.S. Cl. CPC H01R 4/183

(57) ABSTRACT

Compression connector lugs connect to a conductor of a cable for making an electrical connection between the conductor of the cable and other electrical equipment. The cable may be sized and shaped or otherwise configured such that it has a size between 4 AWG and 750 KCMIL. The compression connector lugs include a palm for connecting the compression connector lug to the other electrical equipment and a generally elongate cylindrical barrel, coupled to the palm, for receiving the conductor. A cylindrical sleeve is configured to slidably fit around the cylindrical barrel, the cylindrical sleeve including visual transparent material enabling visual inspection through the cylindrical sleeve.

### FIELD OF THE INVENTION

This invention relates generally to the field of compression connectors for electrical applications, specifically a compression connector lug with a transparent sleeve to increase strip length tolerance and facilitate visual inspection of the compression connection.

### BACKGROUND

Standard compression connector lugs are designed to form secure electrical connections but can be limited by strict requirements on conductor strip length. If a cable is stripped beyond the recommended strip length, the cable has to be covered in electrical tape in order to provide the necessary safety precautions. Traditional designs using electrical tape do not readily allow for inspection of the quality of the connection between the conductor and the compressed portion of the lug, making it challenging to ensure proper installation without disassembly. Certain quality checks after installation are necessary in some applications, which currently require disassembly in order to perform the quality check. Thus, a need exists for improved compression connectors to facilitate improved quality checks.

### SUMMARY

Shortcomings of the prior art are overcome, and additional advantages are provided, through the provision of a compression connector kit that includes a compression connector lug for connecting to a conductor of a cable for making an electrical connection between the conductor of the cable and other electrical equipment, wherein the cable has a size between 4 AWG and 750 KCMIL, the compression connector lug comprises a palm for connecting the compression connector lug to the other electrical equipment. The compression connector lug also comprises a generally elongate cylindrical barrel, coupled to the palm, that includes a cavity for receiving the conductor. The compression connector lug also includes a gap positioned proximate a connection point between the cylindrical barrel and the palm, the gap being positioned to provide visibility to the conductor when received into the cavity. The compression connector kit also includes a cylindrical sleeve configured to be slidably fit around the cylindrical barrel and the gap, the cylindrical sleeve comprising visually transparent material enabling visual inspection through the cylindrical sleeve of the gap when the cylindrical sleeve is positioned over the gap.

A compression connector kit is also disclosed herein that includes a compression connector lug for connecting to a conductor of a cable for making an electrical connection between the conductor of the cable and other electrical equipment. The compression connector lug comprises a connection terminal for connecting the compression connector lug to the other electrical equipment, and a generally elongate cylindrical barrel, coupled to the connection terminal, that includes a cavity for receiving the conductor. The compression connector kit also includes a cylindrical sleeve configured to be slidably fit around the cylindrical barrel, the cylindrical sleeve comprising visually transparent material enabling visual inspection through the cylindrical sleeve of the cylindrical barrel when the cylindrical sleeve is positioned over the cylindrical barrel.

Also disclosed herein is a compression connector system that includes an electrical cable comprising a conductor and a compression connector lug for making an electrical connection between the conductor of the electrical cable to other electrical equipment. The compression connector lug comprises a connection terminal for connecting the compression connector lug to the other electrical equipment and a generally elongate cylindrical barrel, coupled to the connection terminal, that includes a cavity for receiving the conductor. The compression connector system also includes a cylindrical sleeve configured to be slidably fit around the cylindrical barrel, the cylindrical sleeve comprising visually transparent material enabling visual inspection through the cylindrical sleeve of the cylindrical barrel when the cylindrical sleeve is positioned over the cylindrical barrel.

Additional features and advantages are realized through the concepts described herein.

### BRIEF DESCRIPTION

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

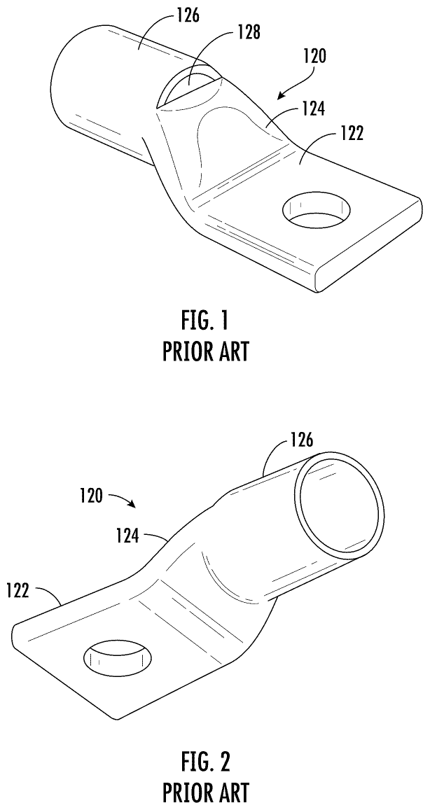

FIG. 1 is a front perspective view of a prior art compression connector lug;

FIG. 2 is a back perspective view of the prior art compression connector lug of FIG. 1;

FIG. 3 is a front perspective view of a compression connector kit with a cylindrical sleeve positioned around the generally elongate barrel of the compression connector lug, according to an embodiment of the present invention;

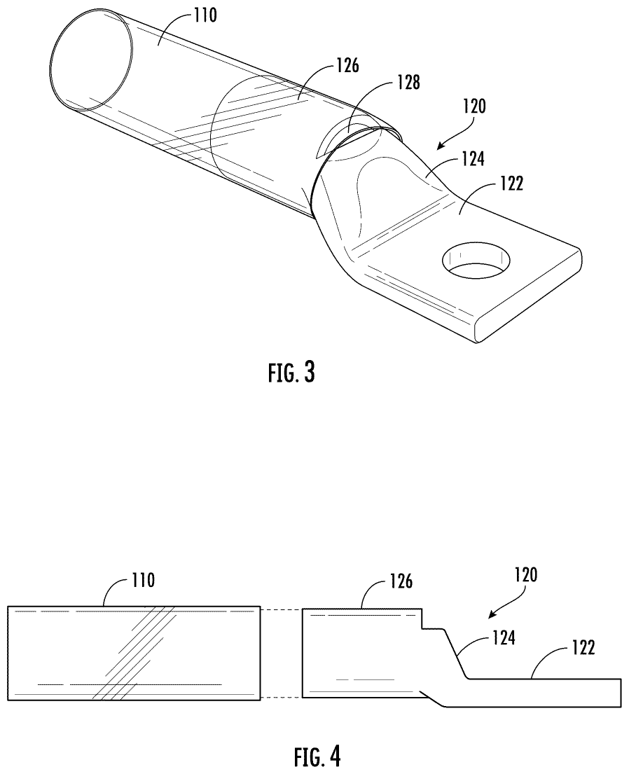

FIG. 4 is an exploded view of the compression connector kit of FIG. 3, according to an embodiment of the present invention;

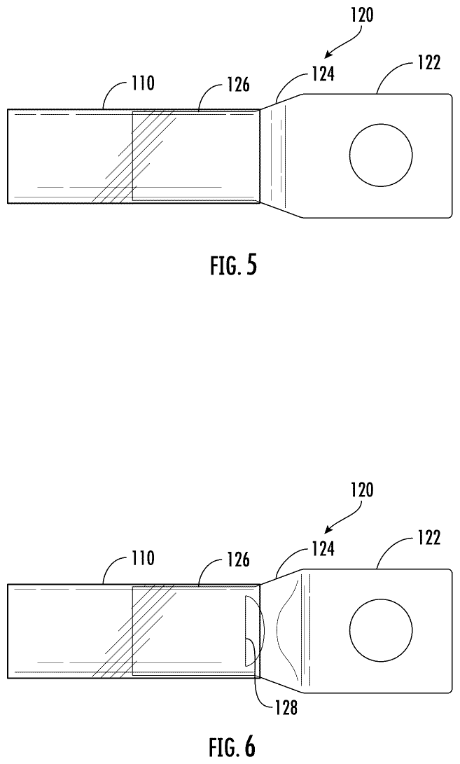

FIG. 5 is a back view of the compression connector kit of FIGS. 3-4, according to an embodiment of the present invention; and

FIG. 6 is a front view of the compression connector kit of FIGS. 3-5, according to an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. are omitted to avoid obscuring the invention with well-known details. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Thus, unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete and will fully convey the scope of the invention and enable one of ordinary skill in the art to make, use, and practice the invention.

The terms “couple,” “coupled,” “couples,” “coupling,” “fixed,” “attached to”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Disclosed herein are compression connector kits and compression connector systems to facility quality inspections of compression connector lug connections without disassembly. Some applications require quality inspections of compression connector lug connections to ensure correct positioning, compression quality, and connection verification. However, technicians may strip the connector beyond the length of the barrel of the compression connector, which requires the technician to tape, using electrical tape, the exposed portion that extends beyond the length of the barrel as a safety precaution. Thus, in such applications that require quality inspections, the inspector must disassemble the tape in order to verify the positioning, compression quality, and connection. Accordingly, a need exists for improved kits and systems that allow for an imprecise and flexible strip length to expose the conductor of the cable while enhancing safety by covering the exposed conductor while enhancing quality inspections and connection safety.

The compression connector kits and compression connector systems disclosed herein utilize a cylindrical sleeve configured to be slidably fit around the cylindrical barrel of the compression connector lug. The cylindrical sleeve allows for an increased strip length tolerance, which reduces the precision technicians would be required to have in stripping the cable and exposing the conductor. The cylindrical sleeve includes a transparent material, which enables the technician to visually inspect the connection without having to disassemble tape in order to verify positioning and compression quality.

FIGS. 1-2 depict an example compression connector lug 120, according to an embodiment of the prior art. The compression connector lug 120 is sized and shaped or otherwise configured to receive, through a cavity positioned in a generally elongate cylindrical barrel 126, a conductor of a cable. The compression connector lug 120 is capable of electrically connecting to the conductor of the cable and other electrical equipment. In some embodiments, the compression connector lug 120 is sized to fit a cable that is between 4 American Wire Gauge (AWG) and 750 Kilo Circular Mils (KCMil). The compression connector lug 120 includes a palm 122 or other connection terminal for connecting the compression connector lug 120 to the other electrical equipment. The palm 122 may include a sloped interconnection 124 connecting the palm 122 to a generally elongate cylindrical barrel 126. The cylindrical barrel 126 is coupled to the palm 122 via the sloped interconnection 124 at a connection point. Proximate the connection point, between the cylindrical barrel 126 and the palm 122, is a gap 128 that is positioned to provide visibility to the conductor when the conductor is received into a cavity 130 of the cylindrical barrel 126.

FIGS. 3-6 depict various view of a compression connector kit that includes a cylindrical sleeve 110 and a compression connector lug 120, according to an embodiment of the present invention. For example, the compression connector kit may incorporate the compression connector lug 120 of FIGS. 1 and 2. The cylindrical sleeve 110 may be sized and shaped or otherwise configured to fit over the diameter of the cylindrical barrel 126. Further, the cylindrical sleeve 110 includes a length that covers the length of the cylindrical barrel 126 and extends beyond the length of the cylindrical barrel 126 to cover at least part of the cable and/or the connector of the cable that is inserted into the cavity 130 of the cylindrical barrel 126. In one embodiment, the cylindrical sleeve 110 is configured to slidably fit around the cylindrical barrel 126 and the gap 128 of the compression connector lug 120. The visually transparent material of the cylindrical sleeve 110 enables visual inspection through the cylindrical sleeve 110 when the cylindrical sleeve 110 is positioned over the gap 128 to inspect, via the gap 128, the conductor positioned within the cavity 130 without disassembly of the cylindrical sleeve 110.

In some embodiments, the end of the cable is stripped for a stripped length to expose the conductor prior to the cylindrical barrel 126 receiving the conductor. The cylindrical sleeve 110 includes a length sufficient to cover the end of the cable that is stripped when the end of the cable that is stripped extends beyond a length of the cylindrical barrel 126. In some embodiments, the cylindrical barrel 126 includes an integrated positioning guide that includes one or more depth markings for indicating a recommended strip length of an end of the cable to expose the conductor. The one or more depth markings are representative of the depth of the cavity 130, which would necessarily correspond to the recommended strip length of the end of the cable. The recommended strip length enhances the likelihood of a sufficient insertion depth of a stripped length of the cable to facilitate an operative connection. The integrated positioning guide may include subtle alignment indicators to assist in positioning the conductor so that the conductor is properly aligned with the compression connector lug 120 in order to enhance compression quality when the cylindrical barrel 126 is compressed. Advantageously, this improves consistency and reliability in conductor positioning by reducing the risk of misalignment and potential connection failures.

Once the strip length of the cable is inserted into the cavity, the cylindrical barrel 126 is compressed around the connector to ensure that there is an electrical connection, and that the compression connector lug 120 does not separate from the conductor. In some embodiments, the cylindrical sleeve 110 is sufficiently long to accommodate variations and long strip lengths exposing the conductor, which provides for imprecise strip lengths. Advantageously, this simplifies the installation process and increases installation efficiency by reducing installation errors that arise due to imprecise strip length requirements.

In one embodiment, the cylindrical sleeve 110 includes a diameter sufficiently snug around a barrel diameter of the cylindrical barrel 126 to protect against introduction of environmental hazards between the cylindrical sleeve 110 and the cylindrical barrel 126. Example environmental hazards can include moisture, dust, and other contaminants. These environmental hazards can degrade the connection over time. Advantageously, the disclosed kits and systems allow for both indoor and outdoor installation where environmental exposure may be a concern.

In one embodiment, the cylindrical sleeve 110 may be made of plastic and the cylindrical barrel 126 comprises a conductive material such as metal that is compressible about the conductor of the electrical cable. The cylindrical sleeve 110 may encase the cylindrical barrel 126 to facilitate visual inspection so that an inspection can confirm the positioning of the conductor and the quality of the compression connection of the cylindrical barrel 126 around the conductor after installation without disassembly. These electrical connections subject to quality control inspections in order to reduce the likelihood of faults associated with a faulty connection. Advantageously, the disclosed systems and kids enhance safety and reliability.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features but is not limited to possessing only those one or more features. Furthermore, a device or structure that is configured in a certain way is configured in at least that way but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

What is claimed is:

1. A compression connector kit, comprising:
a compression connector lug for connecting to a conductor of a cable for making an electrical connection between the conductor of the cable and other electrical equipment, wherein the cable has a size between 4 AWG and 750 KCMIL, the compression connector lug comprises:
a palm for connecting the compression connector lug to the other electrical equipment;
a generally elongate cylindrical barrel, coupled to the palm, that includes a cavity for receiving the conductor; and
a gap positioned proximate a connection point between the cylindrical barrel and the palm, the gap being positioned to provide visibility to the conductor when received into the cavity; and
a cylindrical sleeve configured to be slidably fit around the cylindrical barrel and the gap, the cylindrical sleeve comprising visually transparent material enabling visual inspection through the cylindrical sleeve of the gap when the cylindrical sleeve is positioned over the gap.

2. The compression connector kit of claim 1, wherein an end of the cable is stripped for a stripped length to expose the conductor prior to the barrel receiving the conductor, the cylindrical sleeve including a length sufficient to cover the end of the cable that is stripped when the end of the cable that is stripped extends beyond a length of the cylindrical barrel.

3. The compression connector kit of claim 1, wherein the cylindrical barrel comprises an integrated positioning guide that includes one or more depth markings for indicating a recommended strip length of an end of the cable to expose the conductor, the recommended strip length enhancing a likelihood of a sufficient insertion depth of a stripped length of the cable to facilitate an operative connection.

4. The compression connector kit of claim 1, wherein the cylindrical sleeve includes a diameter sufficiently snug around a barrel diameter of the cylindrical barrel to protect against introduction of environmental hazards between the cylindrical sleeve and the cylindrical barrel.

5. The compression connector kit of claim 4, wherein the environmental hazards include moisture, dust, and contaminants.

6. A compression connector kit, comprising:
a compression connector lug for connecting to a conductor of a cable for making an electrical connection between the conductor of the cable and other electrical equipment, the compression connector lug comprises:
a connection terminal for connecting the compression connector lug to the other electrical equipment; and
a generally elongate cylindrical barrel, coupled to the connection terminal, that includes a cavity for receiving the conductor; and
a cylindrical sleeve configured to be slidably fit around the cylindrical barrel, the cylindrical sleeve comprising visually transparent material enabling visual inspection through the cylindrical sleeve when the cylindrical sleeve is positioned over the cylindrical barrel.

7. The compression connector kit of claim 6, wherein an end of the cable is stripped for a stripped length to expose the conductor prior to the barrel receiving the conductor, the cylindrical sleeve including a length sufficient to cover the end of the cable that is stripped when the end of the cable that is stripped extends beyond a length of the cylindrical barrel.

8. The compression connector kit of claim 6, wherein the cylindrical barrel comprises an integrated positioning guide that includes one or more depth markings for indicating a recommended strip length of an end of the cable to expose the conductor, the recommended strip length enhancing a likelihood of a sufficient insertion depth of a stripped length of the cable to facilitate an operative connection.

9. The compression connector kit of claim 6, wherein the cylindrical sleeve includes a diameter sufficiently snug around a barrel diameter of the cylindrical barrel to protect against introduction of environmental hazards between the cylindrical sleeve and the cylindrical barrel.

10. The compression connector kit of claim 9, wherein the environmental hazards include moisture, dust, and contaminants.

11. The compression connector kit of claim 6, wherein the cable has a size between 4 AWG and 750 KCMIL.

12. The compression connector kit of claim 6, wherein the compression connector lug comprises a gap positioned proximate a connection point between the cylindrical barrel and the connection terminal, the gap being positioned to provide visibility to the conductor when received into the cavity.

13. The compression kit of claim 12, wherein visual transparent material enables visual inspection through the cylindrical sleeve and the gap.

14. A compression connector system, comprising:
an electrical cable comprising a conductor;
a compression connector lug for making an electrical connection between the conductor of the electrical cable to other electrical equipment, the compression connector lug comprising:
a connection terminal for connecting the compression connector lug to the other electrical equipment; and
a generally elongate cylindrical barrel, coupled to the connection terminal, that includes a cavity for receiving the conductor; and
a cylindrical sleeve configured to be slidably fit around the cylindrical barrel, the cylindrical sleeve comprising visually transparent material enabling visual inspection through the cylindrical sleeve when the cylindrical sleeve is positioned over the cylindrical barrel.

15. The compression connector system of claim 13, wherein an end of the cable is stripped for a stripped length to expose the conductor prior to the barrel receiving the conductor, the cylindrical sleeve including a length sufficient to cover the end of the cable that is stripped when the end of the cable that is stripped extends beyond a length of the cylindrical barrel.

16. The compression connector system of claim 13, wherein the cylindrical barrel comprises an integrated positioning guide that includes one or more depth markings for indicating a recommended strip length of an end of the cable to expose the conductor, the recommended strip length enhancing a likelihood of a sufficient insertion depth of a stripped length of the cable to facilitate an operative connection.

17. The compression connector system of claim 13, wherein the cylindrical sleeve includes a diameter sufficiently snug around a barrel diameter of the cylindrical barrel to protect against introduction of environmental hazards between the cylindrical sleeve and the cylindrical barrel.

18. The compression connector system of claim 16, wherein the environmental hazards include moisture, dust, and contaminants.

19. The compression connector system of claim 13, wherein the compression connector lug comprises a gap positioned proximate a connection point between the cylindrical barrel and the connection terminal, the gap being positioned to provide visibility to the conductor when received into the cavity.

20. The compression connector system of claim 13, wherein the cylindrical barrel comprises a conductive material that is compressible about the conductor of the electrical cable.
